(19) United States
(12) Patent Application Publication
(10) Pub. No.: US 2014/0195030 A1
(43) Pub. Date: Jul. 10, 2014

(54) CUTTING DECISION-MAKING SYSTEM AND METHOD FOR DONATED TISSUES

(71) Applicant: WARSAW ORTHOPEDIC, INC., Warsaw, IN (US)

(72) Inventor: Ted Farwell, Minneapolis, MN (US)

(73) Assignee: Warsaw Orthopedic, Inc., Warsaw, IN (US)

(21) Appl. No.: 13/736,154

(22) Filed: Jan. 8, 2013

(51) Int. Cl. G06F 17/50

(52) U.S. Cl. CPC G06F 17/50
USPC 700/98

(57) ABSTRACT

A system and method for cut decision-making to increase tissue yield includes a three-dimensional scanner configured to collect scan data of a tissue sample. A computer system includes a processor and memory and is configured to receive the scan data to generate a digital model of the tissue sample. A computer program is stored in the memory and is configured to compute an optimized cutting plan for the tissue sample. The cutting plan is based on criteria input to the program to determine a best combination of primitives to fit within a volume of the tissue sample. A cutting device is configured to receive the tissue sample and cut the tissue sample in accordance with the cutting plan. Various methods are also disclosed.

### TECHNICAL FIELD

The present disclosure generally relates to medical systems and methods for the recovery of tissues, and more particularly to systems and methods for determining geometries and cut lines in tissue for separating the tissue based upon economy and present need.

### BACKGROUND

Tissue transplantation, both human and non-human, has been successfully employed in the recovery of degenerative diseases or injuries. Tissues such as bone, tendons, ligaments and others are employed regularly in medical procedures. Tissue recovery and transplantation has resulted in increased demand for tissue, and large tissue banks have emerged to coordinate donations in an effort to supply tissue for medical needs.

Bone grafting is one of the most common forms of tissue transplantation in medicine. Recovered bone is a commonly transplanted tissue. Bone may be recovered from a patient's own body for re-implantation, may be recovered from a cadaver (allogenic) or maybe recovered from an animal (xenogenic). A shortage of available bone tissue for transplantation has led to a need for finding ways to find bone substitutes and more efficiently use available supplies. Bone substitutes contain synthetic materials that have no regenerative capabilities and are simply absorbed over time following implantation. Thus, bone substitutes do not provide a complete remedy to the problems associated with inadequate availability of transplant tissue donation. This disclosure provides solutions for these prior art deficiencies.

### SUMMARY

Accordingly, a system and method for cut decision-making to increase tissue yield includes a three-dimensional scanner configured to collect scan data of a tissue sample. A computer system includes a processor and memory and is configured to receive the scan data to generate a digital model of the tissue sample. A computer program is stored in the memory and is configured to compute an optimized cutting plan for the tissue sample. The cutting plan is based on criteria input to the program to determine a best combination of primitives to fit within a volume of the tissue sample. A cutting device is configured to receive the tissue sample and cut the tissue sample in accordance with the cutting plan. Various methods are also disclosed.

In one embodiment, a method for cut decision-making to increase tissue yield, includes scanning a tissue sample in three dimensions to collect dimensional data; generating a digital model of the tissue sample on a computer system having a processor and memory using the dimensional data; computing an optimized cutting plan for the tissue sample, the cutting plan being based on criteria input to a program to determine a best combination of primitives to fit within a volume of the tissue sample; and cutting the tissue sample in accordance with the cutting plan.

### BRIEF DESCRIPTION OF THE DRAWINGS

The present disclosure will become more readily apparent from the specific description accompanied by the following drawings, in which:

FIG. 1 is a block diagram of a system for scanning and cutting a tissue samples in accordance with the principles of the present disclosure;

FIG. 2 is a perspective view of an illustrative digitized bone sample model in accordance with the principles of the present disclosure;

FIG. 3 is a perspective view of the illustrative digitized bone sample model of FIG. 2 after applying an optimized cutting plan in accordance with the principles of the present disclosure; and

FIG. 4 is a flow diagram illustrating a method in accordance with the principles of the present disclosure.

Like reference numerals indicate similar parts throughout the figures.

### DETAILED DESCRIPTION

The exemplary embodiments of systems and methods for scanning and cutting donated tissues are discussed in terms of medical treatment of musculoskeletal disorders and more particularly, in terms of a bone scanning and cutting system that provides optimal usage of donated tissues. It is envisioned that the present disclosure may be employed to improve placement and types of cuts made to donated tissue to increase product yield. In a particularly useful embodiment, a bone is scanned to dimensionally characterize the bone. The bone can be cortical, cancellous or cortico-cancellous of autogenous, allogenic, xenogenic, or transgenic origin.

Scanning may include employing medical imaging techniques (e.g., computed tomography (CT), magnetic resonance (MR), X-rays, etc.) as well as external scanning using lasers, infrared sensors, optical systems, etc. Once dimensionally characterized, a model of the bone is digitally marked, preferably in a virtual system, in accordance with cutting decisions made using a computer method or program. The computer method optimizes the cutting decisions in accordance with a current need, cost, purity of tissue, quantity of product, etc.

It is contemplated that the present disclosure may be employed with other osteal and bone related applications, including those associated with diagnostics and therapeutics. It is also contemplated that the disclosed systems and methods may be alternatively employed in a surgical treatment of a living patient where tissues from the patient are employed in the patient, e.g., in other body regions. The systems and methods of the present disclosure may also be employed on animals, bone models and other non-living substrates, such as, for example, in training, testing and demonstration.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “superior” and “inferior” are relative and used only in the context to the other, and are not necessarily “upper” and “lower”.

Further, as used in the specification and including the appended claims, “treating” or “treatment” of a disease or condition refers to performing a procedure that may include administering one or more products or drugs to a patient in an effort to alleviate signs or symptoms of the disease or condition. Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes procedures that have only a marginal effect on the patient. Treatment can include inhibiting the disease, e.g., arresting its development, or relieving the disease, e.g., causing regression of the disease. For example, treatment can include reducing acute or chronic inflammation; alleviating pain and mitigating and inducing re-growth of new ligament, bone and other tissues; as an adjunct in surgery; and/or any repair procedure. Also, as used in the specification and including the appended claims, the term “tissue” includes soft tissue, ligaments, tendons, cartilage and/or bone unless specifically referred to otherwise. The bone can be cortical, cancellous or cortico-cancellous of autogenous, allogenic, xenogenic, or transgenic origin.

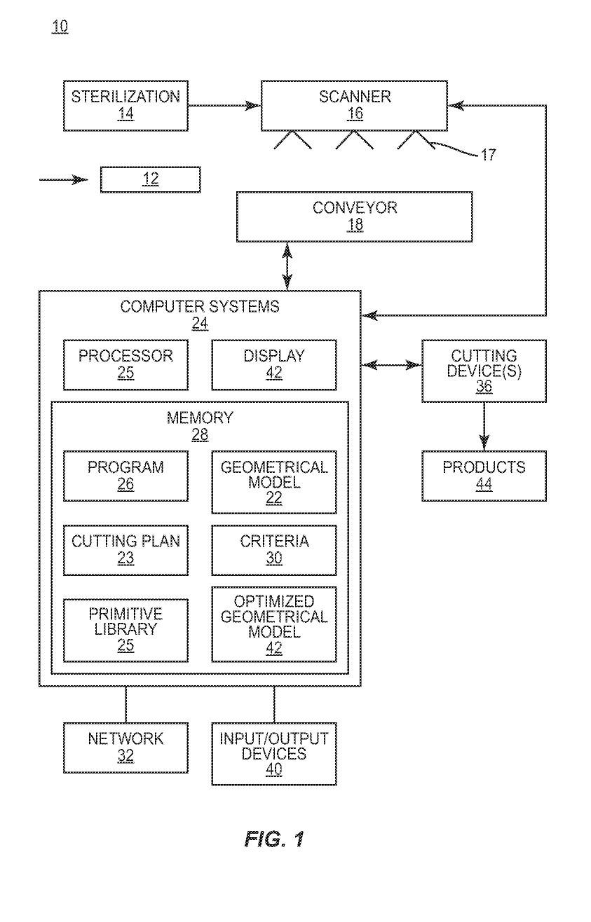

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. The following discussion includes a description of a scanning and cutting decision-making system and method in accordance with the principles of the present disclosure. Alternate embodiments are also disclosed. Reference will now be made in detail to the exemplary embodiments of the present disclosure, which are illustrated in the accompanying figures. Systems and methods will now be described with respect to FIGS. 1-4.

Referring to FIG. 1, in one embodiment, a system 10 for scanning and making cut decisions is illustratively shown. It should be understood that for purposes of the following description, allogenic bone is described as a preferred tissue used to create an implant according to the present principles; however, this tissue is not meant to be limiting. It should therefore be recognized that other types of tissues including, but not limited to, fascia, whole joints, tendons, ligaments, dura, pericardia, heart valves, veins, neural tissue, submucosal tissue, dermis, or cartilage, or combinations thereof and the like, from allogenic, autogenic, and xenogenic sources may also be used in an implant product in accordance with the present principles.

An allogenic bone sample 12 is loaded into a sterilization chamber 14 and sterilized. Sterilization may include application of disinfectants, antibiotic solutions, chemical wash, boiling, or other sterilization process. The bone sample 12 is loaded into a scanner 16. The scanner 16 may include a three-dimensional scanner capable of dimensionally characterizing the bone sample 12. The scanner 16 may include a laser scanner, infrared scanner, light array sensors or other scanning technology to measure bone features relative to a coordinate system to build a geometrical model 20 of the bone samples 12. The model 22 may include a surface model generated using external scanning systems (e.g., laser scanner, infrared scanner, light array sensors) and/or a volumetric model generated using internal scanning systems (e.g., computed tomography (CT), fluoroscopy (X-rays), etc.). For example, the scanner 16 may include one or more imaging systems 20 configured for scanning and characterizing internal and/or external features of the bone sample 12. The imaging system 20 may include, e.g., CT, X-rays, magnetic resonance (MR), etc. The imaging system 20 also can characterize other features of the bone sample 12, such as, e.g., bone density, fracture lines, abnormalities, defects, etc. These other features may be considered along with other criteria when generating a cutting plan 23.

In one embodiment, scanning includes measuring and mathematically features to digitize the bone sample 12. Scanner 16 may include a conveyor 18 to move the bone sample 12 through a scanning area at a known rate. In one embodiment, each of a plurality of scan heads 17 of scanner 16 scans through a scan arc to determine a number of surface points on the bone sample 12. A filtering program may be employed to eliminate outlying points or errors, and curve fitting is employed to fit the points in a continuous surface through the points. A completed cross-section may be conceptualized as an outline of the bone sample 12 (see, e.g., 102 of FIG. 3) at that point. A center point for all cross sections can be determined. Interpolation may be employed to fill in surfaces between the cross-sections and/or points.

The cross-sections may have a computed center with a longitudinal position of each cross-section known from the rate of the conveyor 18. The cross-section positions can be used to generate a centerline for the bone sample 12, using a curve-fitting technique (e.g., a least squares fit). The basic model generated here may be supplemented with information gathered through other modalities as well, if employed. For example, the digital version of the bone sample 12 may have data added to the model 22 from CT scans or MRI data.

The internal and external characterization of the bone sample 12 provides a complete geometrical model 22 of the bone sample 12. The geometrical model 22 is provided to or generated in a computer system 24 and input to a computer program or method 26, stored in memory 28 of the computer system 24.

The computer system 24 includes one or more processors 25 coupled to and working in conjunction with memory 28. The computer system 24 may fully or partially control all steps in the scan and cut system 10. The model 22 is analyzed by the computer method 26 in accordance with criteria 30 to make cutting decisions. The criteria 30 may be user-input and may include information about what products, and which cuts to make based on current industry need, orders placed, detailed specifications, etc. Products may include implants, screws, pins, grafts, etc. The decisions of what to make are based on dimensions of the bone sample 12, desired product mix, product margins, outgoing demand, other raw material (tissue) available, etc. All of this information may be loaded into computer system 24 and/or updated using a public or private network 32. For example, tissue donations may be uploaded to a central website or other network location. The tissue donations may be updated regularly and referenced by the system to determine need and other useful data.

The scanner(s) 16 may be employed to inventory all available tissue donations to assist in planning the cutting decisions collectively for all samples 12. The computer method 26 includes the capability of optimizing cutting decisions based on every single incoming donor, and deciding, and showing what cuts to make, including lathing, if needed.

The computer method 26 includes a library of primitives 34, which may include a plurality of shapes and dimensions for products to be cut from the bone samples 12. Other primitives may be added to the library 34 as needed. Dimensional data taken from the bone sample 12 is evaluated using the method 26, based on present need and/or criteria 30 to assign cutting lines to the bone sample 12 (and/or to all bone samples in a given inventory), which optimizes tissue utilization and minimizes waste generated during subsequent machining.

The computer method 26 generates an optimized geometrical model 35. The optimized geometrical model 35 incorporates primitive shapes for products that are presently needed or otherwise in accordance with the criteria 30 presently guiding the cutting decision-making. The optimized geometrical model 35 may be rendered graphically on a display device 42 for user viewing. The optimized geometrical model 35 may show a digitally rendered version of the bone sample 12 having cut lines and other indicia virtually presented on the optimized geometrical model 35.

The computer system 24 also includes input/output devices 40 such as, for example, a keyboard, a trackball, a touch screen, a mouse, a printer, etc. The input/output devices 40 can be used to calibrate the system 10, view graphical images on the display 42, control the display 42, select points of reference on graphical images, redraw cut lines and/or make other adjustments to the models 22 or 35 and perform various other functions of the system 10. In one embodiment, a user may modify the cut lines in the virtual model 35 by retracing the lines using an interface tool (e.g., a mouse). In addition, other modification may be made such as mapping out a customize portion of the bone sample 12 for a specific or unique application.

It should be understood that embodiments described herein may be entirely hardware, entirely software or including both hardware and software elements. In a preferred embodiment, the present embodiments are implemented using software, e.g., computer method 24, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

The computer system 24 is suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system 10 to enable the data processing system to become coupled to other data processing systems or remote printers or storage devices through intervening private or public networks. Modems, cable modem and Ethernet cards are just a few of the currently available types of network adapters.

The method 26 may further include a capability for accounting for different machining processes employed for cutting the bone samples 12. For example, saw-cutting, milling, lathing, drilling, boring, etc. may all be performed with tools having different dimensions, edges, sizes etc. Method 26, in addition to outputting locations of cuts, holes, etc., may also output the process and size of the tool that will provide an optimal output of product. For example, a saw blade thickness, material and type of machine to do the cutting may all be considered and provided to further enhance the output.

Once optimal cutting decisions have been determined and stored in computer memory 28, the bone sample 12 is sent to a cutting machine or machines 36 which may employed one or more of metal blades, water jet cutting, drills or boring machines, lasers, milling machines, lathes or other cutting devices. The cutting devices 36 may include numerically controlled machines, which can be controlled using the computer system 24. It should be understood the machining may be conducted in a single step or in multiple steps on different platforms or tools.

The bone sample 12 is separated into parts in accordance with the optimized cutting plan 23 output from computer method 26. This dramatically increases yield. Increasing yield reduces constraints placed on finding additional donor sources, and assists in maximizing tissue donations to increase the impact of individual donations.

Once the bone sample 12 has been cut, milled, bored, etc. to create a desired product combination, products 44 may be further processed in accordance with best manufacturing practices. For example, the products 44 may be inspected, re-sterilized, packaged and sent to be used.

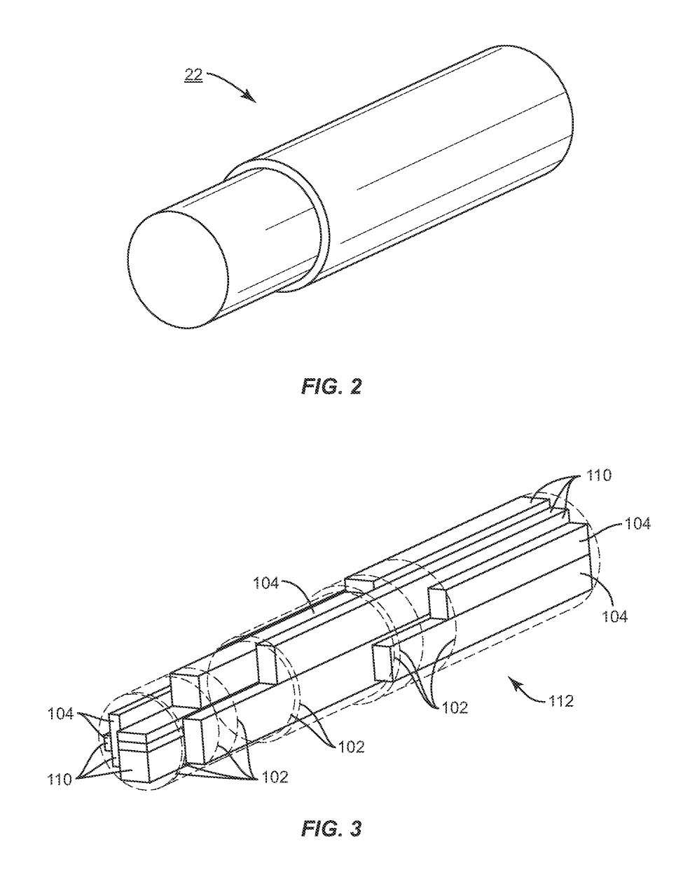

Referring to FIG. 2, an illustrative geometric model 22 for bone sample 12 is illustratively depicted. Geometric model 22 is a digitized version representing the dimensions of the bone sample 12. As described above, the bone sample 12 is analyzed using the criteria described above including but not limited to present demand, available inventory, type of products/primitives in a library, etc.

Referring to FIG. 3 with continued reference to FIG. 1, a visualization of an illustrative optimized geometric model 112 (e.g., model 35) of bone sample 12 is shown in accordance with the present principles. Computer method 26 mathematically computes portions 110 that can fit within circumferential rings or cross-sections 102, which represent an outer surface of the sample 12. Each portion 110 has its dimensions listed in a database or library 34. The method 26 consults the library and tries different permutations and combinations of portions 110 to optimize the amount of volume consumed (within the cross-sections 102). The mathematical computation may include the use of optimized objective functions or other methods, e.g., similar to scan and cut methods employed in the lumber industry, see, e.g., U.S. Pat. No. 6,463,402, issued Oct. 8, 2002 to Bennett et al. Although the cross-sections 102 of bone sample 12 are shown as circles, one skilled in the art should appreciate that the method disclosed will map a variety of complex shapes, accurately reflecting the sample's true cross section. For purposes of visual simplicity, a more complex shape has not been illustrated.

In the illustrative embodiment depicted in FIG. 3, portions 110 include slivers of bone having different lengths, widths and heights. The portions 110 collectively provide a best fit and include spacings for saw blades and/or other cutting tools, e.g., water jets, etc. The portions 110 correspond to primitives of other objects stored in the library 34, and the frequency and placements of the portions 110 will depend on how many portions are currently needed to satisfy a “biggest needs” list, e.g., a priority list of samples or products needed. The computation may include an entire tissue inventory or a given set of tissue samples (e.g., on a daily, weekly, monthly, etc. basis). It should be noted that while the geometric shapes depicted in FIG. 3 are rectangular, other objects and shapes or combinations of shapes may be employed. For example, cylindrical elements, cubic elements, or other elements or combinations of elements may also be employed.

Before cutting the sample 12, the optimized geometric model 112 may be manually reviewed and reconfigured by employing a user interface (devices 40). Changes may be made by the user to customize or reshape a portion 110, or input a new shape not stored in the library 34. The sample 12 is then transported to a cutting machine or device (36). Since the optimized geometric model 112 includes an accurate representation of actually measured dimensions, in one useful embodiment, the cutting machine is preferably computer controlled. In a particularly useful embodiment, a numerical control (NC) machine using computer guided water jets or lasers can accurately follow the marked cuts in optimized geometric model 112 to ensure that material used is maximized and waste is minimized. After cutting, the portions 110 may be re-sterilized and further processed including packaging and transporting.

While the present disclosure has described bone samples as donated tissue to be scanned and cut, the present principles are applicable to soft tissues as well. In one embodiment, soft tissue may be mounted on a rigid material. The rigid material may be designed and configured in many forms to assist in a scan and cut process. The soft tissue and the rigid material would be introduced to the scanner 16 (FIG. 1) and go through the same method as described. The cutting process may employ blade cuts or other appropriate machine or computer guided cutting devices to achieve the desired goals.

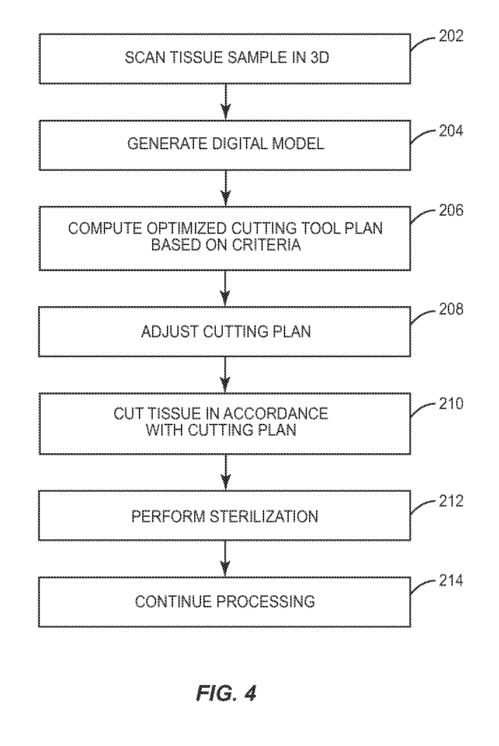

Referring to FIG. 4, a method for cut decision-making to increase tissue yield is illustratively shown in accordance with the present principles. In block 202, a tissue sample is scanned in three dimensions to collect dimensional data of a tissue sample(s), e.g., a bone sample. In block 204, a digital model of the tissue sample is generated, using the dimensional data, on a computer system having a processor and memory.

In block 206, an optimized cutting plan is computed for the tissue sample. The cutting plan is based on criteria input to a program to determine a best combination of primitives to fit within a volume of the tissue sample. The criteria may include user input criteria on current industry need, placed orders, desired product mix, product margins, outgoing demand, raw material available, cost considerations, etc. The cutting plan may include a plurality of different sized portions (e.g., cuttings) corresponding with a plurality of different primitives (commonly employed shapes or pieces) such that multiple different products are concurrently provided by an individual tissue sample. The optimized cutting plan may consider product need based upon a set of tissue samples (e.g., an entire inventory). The cutting plan may be optimized using dimensional data from a plurality of tissue samples all at once.

In one embodiment, the cutting plan is configured to compute an allowance for material removed due to the cutting device. The computer program may be configured to show different configurations of alternative cutting plans in accordance with the type of cutting tools used. Such considerations may have an impact on the cutting plan and may also be optimized using the program in accordance with the present principles. For example, the tissue sample may include bone and the cutting device may cut the tissue sample using one or more of a saw, a laser and a water jet. Each of these modes provides different cuts and different collateral damage may result depending on the method of cutting selected. Also, expense may be input as criteria, and the number and type of costs may be guided by the respective cost. In addition, different combinations of cuts/tools, etc. may be considered in some scenarios.

In block 208, the cutting plan may be adjusted by a user using a user interface. Adjustments may include the type of cutting tool, the type of portions or segments to be cut, the type or combination of primitives to be selected, etc. In block 210, cutting the tissue sample is performed in accordance with the cutting plan. In block 212, sterilization is performed on the cut tissue sample (products). Note that one of more sterilization processes may occur at different times during the procedure. In block 214, processing continues with further machining, packaging, transport, etc.

In accordance with useful embodiments, products formed in accordance with the present principles may be treated with an agent, which may be disposed, packed or layered within, on or about the components and/or surfaces thereof. It is envisioned that the agent may include bone growth promoting material.

It is contemplated that the agent may include therapeutic polynucleotides or polypeptides. It is further contemplated that the agent may include biocompatible materials, such as, for example, biocompatible metals and/or rigid polymers, such as, titanium elements, metal powders of titanium or titanium compositions, sterile bone materials, such as other allograft or xenograft materials, synthetic bone materials such as coral and calcium compositions, such as HA, calcium phosphate and calcium sulfite, biologically active agents, for example, gradual release compositions such as by blending in a bioresorbable polymer that releases the biologically active agent or agents in an appropriate time dependent fashion as the polymer degrades within a patient. Suitable biologically active agents include, for example, BMP, Growth and Differentiation Factors proteins (GDF) and cytokines. The products can be made to include radiolucent materials such as polymers. Radiomarkers may be included for identification under x-ray, fluoroscopy, CT or other imaging techniques. It is envisioned that the agent may include one or a plurality of therapeutic agents and/or pharmacological agents for release, including sustained release, to treat, for example, pain, inflammation and degeneration.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A system for cut decision-making to increase tissue yield, comprising: a three-dimensional scanner configured to collect scan data of a tissue sample; a computer system having a processor and memory and being configured to receive the scan data to generate a digital model of the tissue sample; a computer program stored in the memory and configured to compute an optimized cutting plan for the tissue sample, the cutting plan being based on criteria input to the program to determine a best combination of primitives to fit within a volume of the tissue sample; and a cutting device configured to receive the tissue sample and cut the tissue sample in accordance with the cutting plan.

2. The system of claim 1, wherein the memory includes a library, which stores the primitives, the primitives including desired product shapes.

3. The system of claim 1, wherein the cutting plan includes a plurality of different sized portions corresponding with a plurality of different primitives such that multiple different products are concurrently provided by an individual tissue sample.

4. The system of claim 1, wherein the computer program considers product need based upon a set of tissue samples and optimizes the cutting plan using scan data from a plurality of tissue samples.

5. The system of claim 1, wherein the three-dimensional scanner includes external and internal scanning devices.

6. The system of claim 5, wherein the internal scanning devices include one or more of computed tomography and fluoroscopy.

7. The system of claim 5, wherein the external scanning devices include one or more of a laser scanner and an infrared scanner.

8. The system of claim 1, wherein the tissue sample includes bone and the cutting device includes a saw, a laser or a water jet.

9. The system of claim 1, wherein the cutting plan includes allowance for material removed due to the cutting device.

10. The system of claim 1, further comprising a user interface, and the computer program being configured to permit user input to adjust the cutting plan.

11. The system of claim 10, wherein the user interface permits introduction of a new portion into the cutting plan.

12. The system of claim 1, wherein the criteria includes user input criteria on current industry need, placed orders, desired product mix, product margins, outgoing demand, and raw material available.

13. The system of claim 1, wherein the criteria includes industry demand determined by collecting information from a communication network.

14. A method for cut decision-making to increase tissue yield, comprising: scanning a tissue sample in three dimensions to collect dimensional data; generating a digital model of the tissue sample on a computer system having a processor and memory using the dimensional data; computing an optimized cutting plan for the tissue sample, the cutting plan being based on criteria input to a program to determine a best combination of primitives to fit within a volume of the tissue sample; and cutting the tissue sample in accordance with the cutting plan.

15. The method of claim 14, wherein the cutting plan includes a plurality of different sized portions corresponding with a plurality of different primitives such that multiple different products are concurrently provided by an individual tissue sample.

16. The method of claim 14, wherein computing an optimized cutting plan includes considering product need based upon a set of tissue samples and optimizing the cutting plan using dimensional data from a plurality of tissue samples.

17. The method of claim 14, wherein the tissue sample includes bone and the cutting device cuts the tissue sample using one or more of a saw, a laser and a water jet.

18. The method of claim 14, wherein the cutting plan includes allowance for material removed due to the cutting device.

19. The method of claim 14, further comprising adjusting the cutting plan by a user using a user interface.

20. The method of claim 14, wherein the criteria includes user input criteria on current industry need, placed orders, desired product mix, product margins, outgoing demand, and raw material available.
